(19) United States
(12) Patent Application Publication
(10) Pub. No.: US 2005/0272494 A1
(43) Pub. Date: Dec. 8, 2005

(54) Method of conducting a contest involving a movie mystery

(76) Inventor: Sophia Grinnan, Chantilly, VA (US)

Correspondence Address: H JAY SPIEGEL, P.O. BOX 444, MOUNT VERNON, VA, 22121, US

(21) Appl. No.: 10/859,568

(22) Filed: Jun. 3, 2004

(51) Int. Cl. G06F 19/00; G06F 17/00

(52) U.S. Cl. 463/1

(57) ABSTRACT

The present invention revolves around the production of a movie. The movie is shown concurrently with the conducting of a contest. The contest provides one or more prizes to those persons who are able to solve the mystery or mysteries incorporated into the production of the movie. Entries from all contestants are compiled until the deadline for receiving contest entries has passed. At that point, in complete confidence, the entries are examined for content to determine one or more winners. If it is desired to only award a single winner, tie-breaking procedures are then applied. In a further aspect, it is possible that the contest can involve a viewer viewing a sequel to the original movie in which clues to the solution of the mystery or mysteries contained in the first movie can be provided. If desired, as a feature of the contest, contest kits can be either given to contestants or sold to them at the movie theater or elsewhere.

### BACKGROUND OF THE INVENTION

The present invention relates to a method of conducting a contest involving a movie mystery. In the prior art, it is well known to conduct contests of varying kinds. Often, contests are conducted through the U.S. Mail or through some other delivery means in which contestants fill out and return an entry form and the winner is chosen using desired criteria.

In the movie industry, one genre of movie includes a plot involving a mystery. While watching the movie, the viewer is often entertained by a plot line in which a mystery is solved during the course of the movie. Thus, as the plot unwinds, events occur for which the characters causing the events to occur are not revealed. However, typically, by the end of the movie, the characters perpetrating the mystery are, in fact, revealed to the viewer(s).

In other cases, more rarely, the viewer is required to watch a sequel to unravel mysterious aspects of the first movie with the sequel being shown subsequently. However, Applicant is unaware of any movie production in which a contest is concurrently conducted in which viewers of the movie are permitted to participate and make educated guesses as to the solution to the mystery and where the winner or winners of the contest win one or more prizes.

It is with this thought in mind, particularly, production of a movie having a mystery theme in which the viewers enter a contest seeking to guess or determine the answer to the mystery, that the present invention was developed.

### SUMMARY OF THE INVENTION

The present invention relates to a method of conducting a contest involving a movie mystery. The present invention includes the following interrelated objects, aspects and features:

(1) In a first aspect, the present invention revolves around the production of a movie using any known storage medium such as, for example, film, tape, computer disc, etc. A variety of themes may form the basis for the movie script, however, the common thread throughout all of them is the fact that the actual movie has a mysterious aspect to it. For example, the movie can conceivably revolve around the murder of one or more persons with the identity of the murderer(s) and the motive(s), among other aspects, remaining unrevealed at the conclusion of the movie.

(2) Members of the public who are deciding whether to attend the movie at a movie theater or other screening location are informed that the movie is being shown concurrently with the conducting of a contest. The contest provides one or more prizes to those persons who are able to solve the mystery or mysteries incorporated into the production of the movie.

(3) Viewers of the movie who attend its screening in one or more locations are permitted to take notes concerning what occurs on the screen. After they have viewed the movie, a guideline is provided within which a contest entry must be furnished to the contest operator.

(4) Entries from all contestants are compiled at a central location or at a plurality of locations until the deadline for receiving contest entries has passed. At that point, in complete confidence, the entries are examined.

(5) During the examination of the entries, criteria are applied during the examination process that may cause one or more entries to be disqualified. Once all of the entries that will be disqualified are disqualified, the remaining entries are examined for content to determine one or more winners.

(6) If it is desired to only award a single winner, tie-breaking procedures are then applied. For example, a single winner can be determined by examining the entries to determine which correct entry was submitted first. Other tie-breaking procedures can easily be followed. For example, if, after the first movie (the movie containing the clues), there is no winner, then the following procedure may be set in place. A telephone number will be set up where there will be an automated system in place for a vote. The caller would dial the phone and the automated answering machine will be activated asking the caller to commit to one of two answers. Press one if the movie should be re-released and the contest be replayed, or press two if you give-up and want to see the final movie containing the answers. The majority voters will win and the movie and contest will be either replayed or not. The voting system will be given during a short period of time and there will be one vote per telephone number. There may also be an automated voting system on-line.

(7) In a further aspect, it is possible that the contest can involve a viewer viewing a sequel to the original movie in which clues to the solution of the mystery or mysteries contained in the first movie can be provided. In this scenario, the mystery contest involves three separate parts, that is, three consecutive successively shown movies. Alternatively or concurrently, the sequel can be used after a winner has been chosen to reveal, in the context of the sequel, the solution to the mystery.

(8) If desired, as a feature of the contest, contest kits can be either given to contestants or sold to them at the movie theater or elsewhere. The kits can include, for example, note paper, pen and other items such as, for example, crime scene photos, excerpts from the movie script, a writing instrument, and an entry form provided to facilitate entering the contest and the entry process.

(9) If desired, either the contest kit or a separate publication can be used to cause potential contestants to be interested in attending the movie and entering the contest, which can include a synopsis of what will occur in the movie, biographical information concerning the actors and actresses involved, and information concerning the production company.

(10) In order that the contest can be conducted in a fair manner, the first movie must be released on the same day at the same time at every theater where the movie is shown. The timing is important given the tie-breaking procedures described above. Thus, if the movie is going to open at 1:00 PM on the chosen day in New York City, it must open at 10:00 AM in Los Angeles on the same date. Similarly, the contest deadline will be the same moment in time regardless of time zone.

As such, it is a first object of the present invention to provide a method of conducting a contest involving a movie mystery.

It is a further object of the present invention to provide such a method in which a movie script is created and produced involving mysterious aspects that are not overtly solved by the end of the movie.

It is a further object of the present invention to concurrently provide a contest having appropriate rules and regulations in which contestants guess as to the solution(s) to the mystery(ies) involved in the movie.

It is a still further object of the present invention to provide such a method in which contestants may be provided with a contest kit including a movie entry form and other items that help facilitate entering the contest.

It is a still further object of the present invention to provide such a contest in which tie-breaking procedures are provided to ensure that the desired number of winners can be chosen.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a flowchart of the steps taken to create a movie and contest in accordance with the teachings of the present invention.

FIG. 2 shows a flowchart depicting the steps taken by a contestant in entering the inventive contest.

FIG. 3 shows the process for receiving entry forms and determining one or more winners.

### SPECIFIC DESCRIPTION OF THE PREFERRED EMBODIMENTS

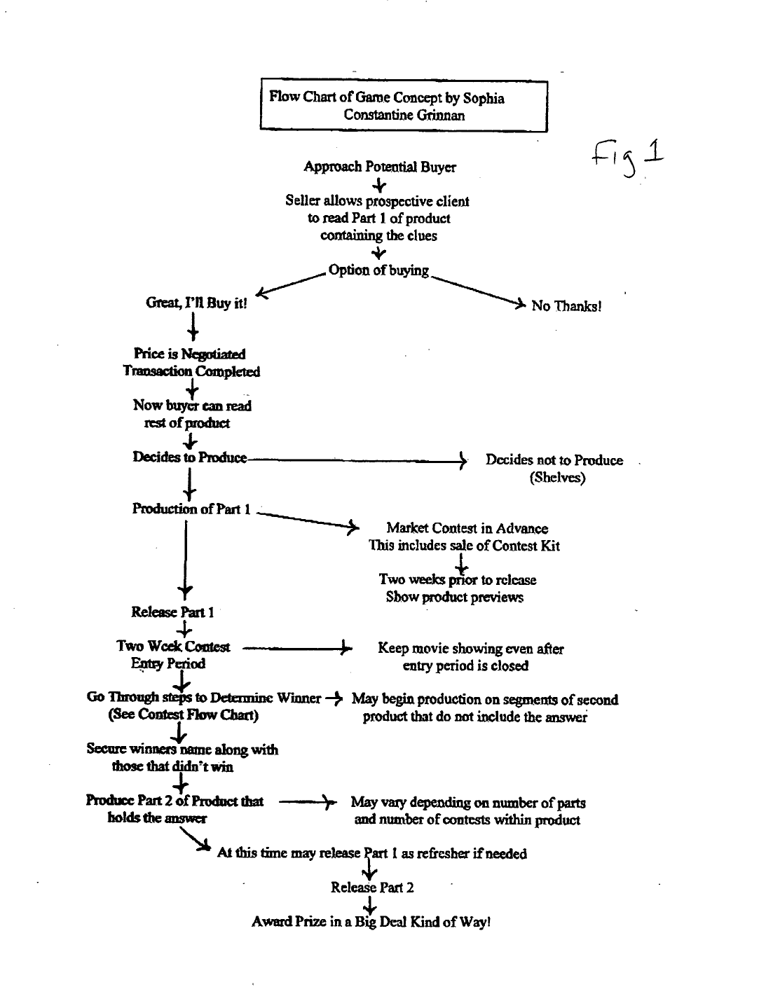

With reference to FIGS. 1-3, the present invention will be described in detail. To best understand the salient aspects of the present invention, the explanation has three parts, a first part involving the manner by which the movie is produced and promoted, in a second aspect, a description of the contest from the perspective of the contestant, and in a third aspect, those aspects of the method concerning receipt of filled-out entries and grading them to determine one or more winners.

With reference to FIG. 1, a screenplay is prepared, either by a production company or by a private party for presentation to the production company. In either case, extreme secrecy is essential to the success of the inventive method. In the case where a private entity has prepared the screenplay, after that process is completed, at least to the extent in which the screenplay is in a condition for marketing, a prospective movie producer is approached and a confidential presentation is made which may or may not result in the movie producer deciding to enter into an agreement with the private entity to produce the movie and operate the contest.

In the event an agreement is reached, the movie is produced with complete secrecy. Numerous steps are taken to ensure that details of the movie that would permit a contestant to solve the mystery are not revealed to the public. As a first measure, every employee who enters the movie set, including every actor and actress, is required to sign a strict confidentiality agreement. One example of a measure that may be employed to ensure compliance with the confidentiality requirements is to hold back a negotiated percentage of the monies owed the employee, actor or actress until such time as the contest has concluded, whereupon the withheld monies are paid. Any such agreement would also include the ability to obtain quick injunctive relief against anyone who might be found to be revealing any confidential aspects of the movie plot.

In a further aspect, it is possible to arrange which actors and actresses are included in each scene and to bar actors and actresses from the set who are not specifically performing in a scene so that each actor or actress only knows a portion of what has been filmed, but not the entirety of the plot.

Concurrently with production of the movie, marketing materials are prepared for the contest including, if desired, production of a contest kit including a variety of materials including, for example, a writing instrument, paper, written and photographic materials assisting the contestant in recalling important aspects of the movie plot as well as an entry form including instructions as to how to enter the contest.

Marketing and advertising materials are also prepared to promote both the movie and the contest.

In connection with preparation of the contest, edits are made as necessary to the plot of the movie before and during production to ensure that enough variables are left unsettled at the conclusion of the movie to permit an interesting and exciting contest to take place and to limit the number of winners that result from the contest.

In creating the contest, rules must be prepared that not only help determine an eventual winner, but also are used to disqualify entries that do not comply with logical and required standards. For example, it might be required that entries be presented in one particular language such as, for example, English. Alternatively, it is possible to allow entries to be presented in any one or more of a number of languages. It might be a requirement that writing be legible. A procedure could be implemented to facilitate disqualification of entries that are not legible. For example, it could be a requirement of the review process that a plurality of people review each entry where legibility becomes an issue. If all of the reviewers conclude that the entry is not legible, it is disqualified. If necessary, it could be required that entries are typewritten.

It might be another requirement of an entry that it be signed and dated by the contestant and, for tie-breaking purposes, perhaps a time stamp could be required, stamped with date and time upon receiving entry.

Another requirement could be that answers to questions involved in solving the mystery be limited to a certain number of words, i.e., 25 words or less. Security measures are provided to deter fraudulent claims.

Provisions could be included, as are customary in contests, that the decision of the judges is final and not appealable. An age limitation could be imposed such that only persons of the age of majority could enter the contest.

The prize could be multi-faceted or of a single type. Thus, the prize could be a pre-determined monetary amount, or could additionally include merchandise, a trip or anything else of value. One aspect of the contest could be that the winner or winners get to meet the actors and actresses who are the stars of the movie. Such an aspect of the prize would provide a great incentive to the members of the general public to attend the movie and compete in the contest.

If desired, a means could be provided to allow players to interact with the contest giver to obtain clues to assist the contestant in solving the mystery. Such communications could occur by telephone or on a computer via a global computer network such as, for example, the INTERNET.

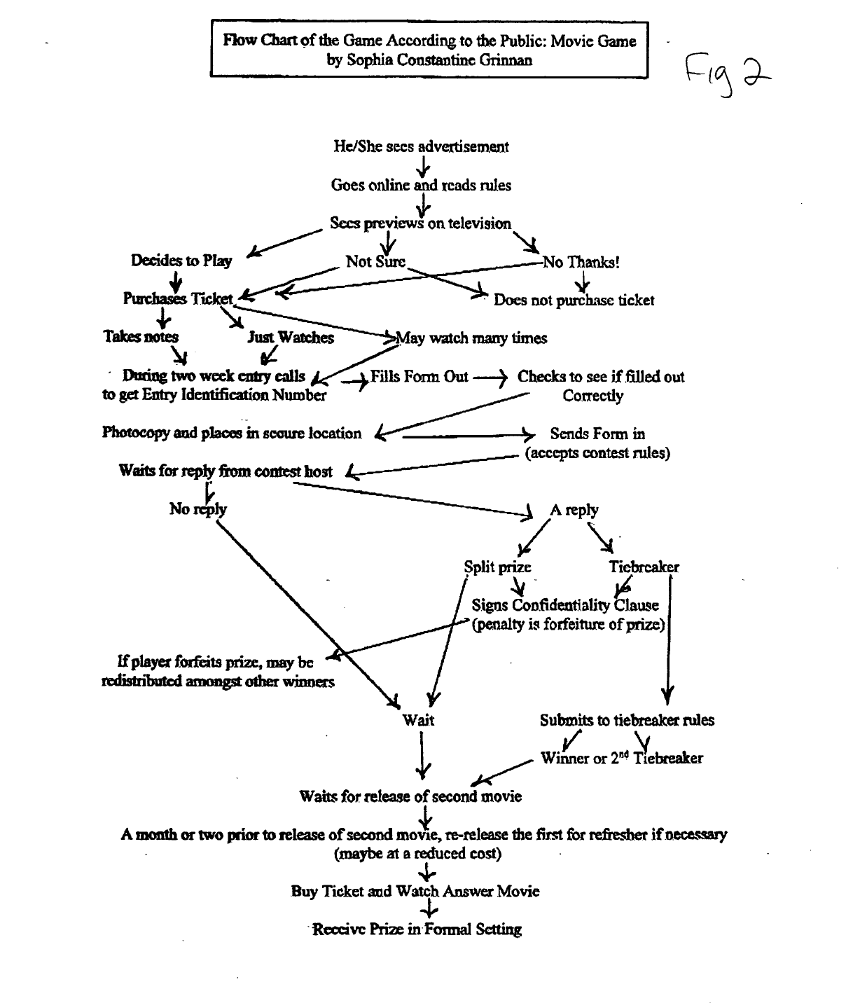

With reference now to FIG. 2, the present invention will be discussed in more detail from the perspective of a contestant. The contestant finds out about the contest and movie concurrently, and makes a decision about whether he or she is interested in proceeding. Advertisements are read and a web site is provided that permits a prospective contestant to read more about the movie and the contest as well as the rules to which contestants must adhere. Previews for the movie and the contest are seen both on television and in movie theaters in advance of the showing of other earlier released movies.

If the prospective contestant decides to see the movie, it is not necessary that he or she become a contestant. A person is fully able to watch and enjoy the movie without needing to enter the contest. If, however, the prospective viewer also wishes to become a contestant, they may freely choose to do so by purchasing a ticket to watch the movie. If the prospective contestant so desires, they can purchase a kit either at the movie theater or, perhaps, at a video store, that would be helpful to them in viewing the movie and entering the contest. The supplies that may be included in the contest kit have been described in detail above. A viewer may view the movie once or, if desired, may view the movie as many times as necessary to formulate a contest entry. Of course, the viewer is informed that one tie-breaker in the contest is the date and time at which the entry is received by the contest operator. As such, while it might be advantageous to see the movie a plurality of times, it is quite possible that this would result in the multiple viewer submitting an entry later in time than another entry that would be in a superior position due to its greater timeliness.

After the viewer is satisfied that he or she has a sufficient understanding of the movie to submit a credible entry, the entry form is filled out and submitted in a manner in accordance with the rules and regulations of the contest.

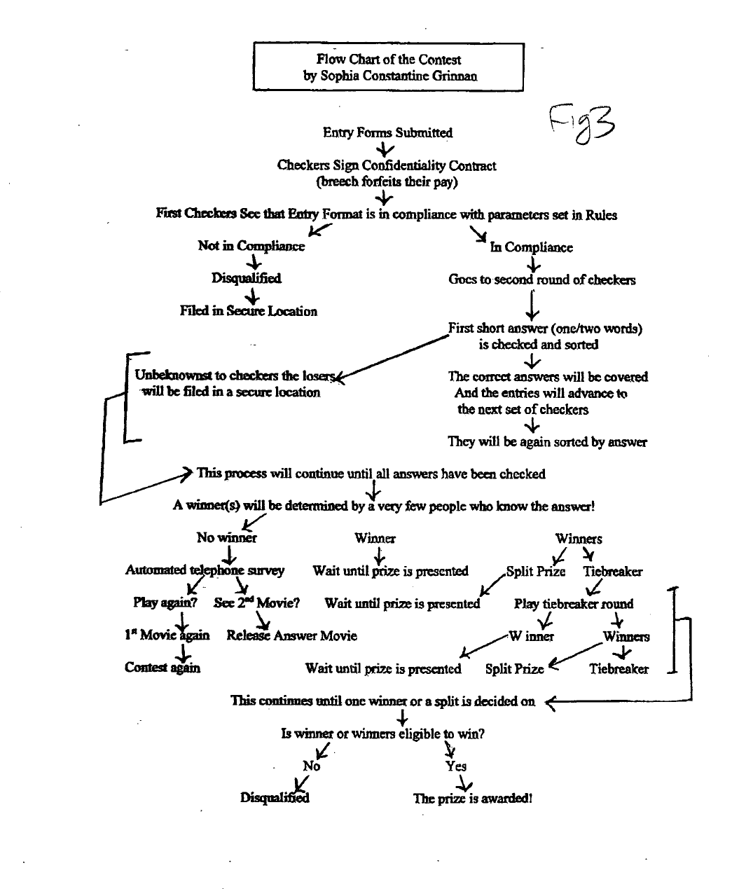

With reference to FIG. 3, entries from all of the contestants are compiled and stored in a safe, secure location until such time as the deadline for entries has arrived. Meanwhile, checkers are hired to grade the entries and they are required to sign confidentiality agreements. Once the deadline for entries has passed, the entries are examined in the manner explained hereinabove, entries that do not meet the standards of the contest as set forth in the rules and regulations are disqualified, and the remaining entries are reviewed by a secret panel to determine which entries, if any, are complete in every respect and solve the mystery.

It is contemplated, that a correct solution to the mystery will not only include the identity of the character or characters who have engaged in an act for which the solution is sought but, also, will include underlying facts that are also mysterious during the course of playing of the movie. For example, in the case where the movie involves a mysterious murder, a correct entry will be required, for example, to include not only the identity of the murderer or murderers, but also their specific motive or motives and any other underlying facts that the contest operators choose to include as a requirement of a winning entry. These requirements will be specifically spelled out, not only in the published publicly available contest rules, provided in advance of the first showing of the first movie, but also will be displayed at the beginning and end of the movie as shown in the movie theater.

Once the deadline for entries has passed and the entries have been screened and reviewed, a winner or winners is/are declared using whatever tie-breaking procedures were set in place before the contest began. As an alternative, it is entirely feasible that a sequel to the original movie is confidentially produced that provides the solution to the mystery. The promotion of the sequel can involve encouraging viewers to attend the sequel to find out the solution to the mystery.

If desired, in anticipation of release of the sequel, it is entirely feasible to re-release the original movie for a short run so that those persons who did not see the movie, whether or not they entered the contest, can view the movie and understand the mystery to better facilitate understanding of the solution to the mystery as revealed in the sequel.

If desired, prizes for the winner or winners can be awarded in a formal manner at a public setting with the stars of the movie present or any other dignitaries invited to attend, as well. If desired, a plurality of winners can split the listed prizes.

As such, an invention has been disclosed in terms of preferred embodiments thereof set forth in varying alternative manners of conducting the present invention which fulfill each and every one of the objects of the present invention as set forth hereinabove, and provide a new and useful method of conducting a contest involving a movie mystery of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. Method of conducting a contest including the steps of:
a) producing a motion picture stored on a storage medium permitting repeated re-play;
b) providing said motion picture with a plot including a mysterious ending not readily discernible from watching said motion picture;
c) providing said plot with at least one undisclosed fact that must be determined in order to solve said mysterious ending;
d) providing at least one location where members of the public may view said motion picture;
e) providing entry means for facilitating entering into a contest for which one or more prizes will be awarded;
f) whereby at least one prize is awarded to a member of the public who determines said at least one undisclosed fact and said mysterious ending.

2. The method of claim 1, wherein said producing step includes the step of preparing a screenplay.

3. The method of claim 1, wherein said storage medium is chosen from the group consisting of film, tape and a computer disc.

4. The method of claim 1, wherein said plot comprises a murder mystery.

5. The method of claim 4, wherein said at least one undisclosed fact comprises a motive for a murder.

6. The method of claim 5, wherein said mysterious ending for which said contest is conducted consists of an identity of a murderer.

7. The method of claim 1, wherein said at least one location comprises a plurality of locations.

8. The method of claim 7, wherein said plurality of locations are in a plurality of time zones.

9. The method of claim 1, wherein said entry means comprises a printed form.

10. The method of claim 1, wherein said contest is conducted with a set of rules that must be followed by contestants.

11. The method of claim 10, wherein said rules include tie-breaking procedures should more than one person submit a winning entry.

12. The method of claim 11, wherein said tie-breaking procedures include determining which winning entry was submitted earliest.

13. The method of claim 1, wherein said producing step is conducted in secrecy.

14. The method of claim 13, wherein said producing step includes the step of hiring actors to play roles in said motion picture.

15. The method of claim 14, wherein said hiring step includes the step of requiring actors to sign a confidentiality agreement.

16. Method of conducting a contest including the steps of:
a) producing a motion picture in a confidential setting and storing said motion picture on a storage medium permitting repeated re-play;
b) providing said motion picture with a plot comprising a murder mystery including a mysterious ending including the identity of a murderer not readily discernible from watching said motion picture;
c) providing said plot with at least one undisclosed fact, consisting of a motive for a murder, that must be determined in order to solve said mysterious ending;
d) providing a plurality of locations where members of the public may view said motion picture;
e) providing entry means comprising a printed form for facilitating entering into a contest for which one or more prizes will be awarded;
f) whereby at least one prize is awarded to a member of the public who determines said at least one undisclosed fact and said mysterious ending.

17. The method of claim 16, wherein said producing step includes the step of preparing a screenplay.

18. The method of claim 16, wherein said storage medium is chosen from the group consisting of film, tape and a computer disc.

19. The method of claim 16, wherein said plurality of locations are in a plurality of time zones.

20. The method of claim 16, wherein said contest is conducted with a set of rules that must be followed by contestants, said rules including tie-breaking procedures should more than one person submit a winning entry, said tie-breaking procedures including determining which winning entry was submitted earliest.
